(19) United States
(12) Patent Application Publication
(10) Pub. No.: US 2025/0353047 A1
(43) Pub. Date: Nov. 20, 2025

(54) INITIATING SELF CLEANING BASED ON SENSOR DRIFT

(71) Applicant: Microchip Technology Incorporated, Chandler, AZ (US)

(72) Inventors: Patrick McFarland, Gilbert, AZ (US); Arthur B. Eck, Gilbert, AZ (US)

(73) Assignee: Microchip Technology Incorporated, Chandler, AZ (US)

(21) Appl. No.: 18/957,302

(22) Filed: Nov. 22, 2024

Related U.S. Application Data
(60) Provisional application No. 63/648,590, filed on May 16, 2024.

(51) Int. Cl. B08B 7/02; B08B 11/00; G01D 18/00

(52) U.S. Cl. CPC B08B 7/026; B08B 11/00; G01D 18/00; G01D 2218/10

(57) ABSTRACT

A method includes detecting a first signal from a sensor of a life safety device, the first signal to represent a first baseline for a characteristic of the sensor. A second signal may be detected from the sensor, the second signal to represent a second baseline for the characteristic of the sensor. The second baseline may be compared to the first baseline to determine a first measure of sensor drift for the characteristic of the sensor. The first measure of sensor drift may be compared to a first drift threshold, and a self-cleaning session may be initiated when the first measure of sensor drift exceeds the first drift threshold. The self-cleaning session may include at least one self-cleaning cycle.

### PRIORITY STATEMENT

This application claims priority to U.S. Provisional Patent Application No. 63/648,590 filed May 16, 2024, the contents of which are hereby incorporated in their entirety.

### TECHNICAL FIELD

The present disclosure relates to safety devices such as smoke alarms and, more particularly, to initiating a self-cleaning safety system based on sensor drift and evaluating the effectiveness of self-cleaning operations.

### BACKGROUND

Life safety devices, such as smoke detectors and carbon monoxide detectors, rely on various sensors to detect different types of hazards and environmental conditions. For example, some smoke detectors include a photoelectric detector, an ionization detector, or a combination of both. In a photoelectric smoke detector, an alarm may be triggered when smoke is detected based upon the amount of light detected from a light source onto a light sensor. In an ionization smoke detector, ionized air molecules attach to the smoke particles that enter the chamber, changing the ionizing current, which may result in an alarm being triggered based on the change in the ionizing current. Such smoke detectors may be used to detect fires in large commercial and industrial buildings, as components in a larger fire alarm system.

In general, the ionization detector reacts faster than the photoelectric detector in responding to flaming fires, and the photoelectric detector is more responsive to smoldering fires. Because an ion detector tests the air for small combustible particles, it can be fooled by chemical or paint particles in the atmosphere. The photoelectric detector, which needs to “see” the smoke from the fire, can be fooled by objects, dust, humidity, or even insects. Though both offer protection against undetected fires, ionization detectors experience a higher incidence of nuisance alarms.

Photoelectric smoke detectors may also be referred to as optical beam smoke detectors. Photoelectric smoke detectors include at least one light transmitter and one light sensor to receive the transmitted light. The photosensitive receiver is used to monitor light received from the transmitter, both under normal conditions and under hazardous conditions. There are two primary types of photoelectric smoke detectors, the light-obscuration type and the optical-scattering type. The principle of light obscuration, where the presence of smoke blocks some of the light from the light source beam from reaching the light sensor. In the absence of smoke, light passes from the light transmitter to the receiver in a straight line. In a fire, when smoke falls within the path of the beam detector, some of the light is obscured (e.g., absorbed or scattered by the smoke particles). This creates a decrease in the received light signal from the light sensor, leading to an increase in optical obscuration, which is a reduction of transmittance of light across the beam path. Once a certain percentage of the transmitted light has been obscured by the smoke compared to a baseline signal, a fire alarm may be triggered. In the light-scattering type detector, the optical beam does not align with the photosensor so that under normal conditions no or very little light is received by the photosensor. When smoke particles enter the photo chamber, smoke is scattered or reflected onto the photosensor, and alarm may be triggered when the scattered light detected by the photosensor exceeds a threshold value when compared to a baseline signal. In either case, operation of the safety device may be impaired by the build up of dust or other debris on the outside of the photo chamber or of a mesh surrounding the photo chamber or otherwise covering the air inlet to the photo chamber that impedes the ability of smoke to enter the chamber during a hazardous condition such as a fire. Operation of the safety device may also be impaired by the buildup of dust or other debris on components inside the photo chamber.

Inventors of examples of the present disclosure have discovered that a lack of cleaning of safety devices, such as smoke and carbon monoxide detectors, may account for a significant percentage of failures to alarm during an emergency. In the case of smoke detectors, this failure to alarm due to lack of cleaning has increased over the past decade. This is especially prominent with hardwired safety devices, likely due to a lack of maintenance from not needing to regularly replace batteries. The failure of a safety device to alarm is a significant hazard, and in the case of dirty smoke detectors, results in numerous preventable deaths and injuries each year, as well as substantial property damage.

The baseline signal may be provided, for example, during initial calibration of the safety device and may be recorded in safety device memory. The baseline signal may degrade over time due to the accumulation of dust or other debris, which may be referred to as sensor drift. During operation, the safety device may compare measured signals against the baseline signal to determine a signal that would indicate a hazardous condition. Some solutions to address sensor drift may involve adjusting the baseline signal by some factor to keep it within an acceptable range for hazardous condition detection. Inventors of examples of the present disclosure have discovered that, while this approach might work in theory, in practice it is not sufficient due to quickly running out of headroom, which is the difference between a normal state indicated by the baseline signal and an alarm state, over time. This is evidenced by the significant and increasing number of smoke alarm failures over time, despite improving technology and safety standards. While this method may account for some sensor drift, it fails to address the cause of the sensor drift. Addressing the cause of sensor drift may provide improved headroom over the service life of the life safety device.

Inventors of examples of the present disclosure have discovered that other solutions fail to effectively address the problem of the build-up itself of contaminants on the housing and lack routine maintenance. Inventors of examples of the present disclosure have identified that other solutions have been focused on detection of the dust and debris and an internal compensation applied to the alarm sensitivity. Inventors of examples of the present disclosure have identified that other solutions would sound a warning or fault signal when the detected dust and debris surpassed a certain preset level. Inventors of examples of the present disclosure have discovered that none of these solutions have addressed the actual issue of accumulation itself.

There is a need for life safety devices that maintain effectiveness over time and use.

### SUMMARY

According to an aspect, there is provided a method, comprising: detecting a first signal from a sensor of a life safety device, the first signal to represent a first baseline for a characteristic of the sensor; detecting a second signal from the sensor, the second signal to represent a second baseline for the characteristic of the sensor; comparing the second baseline to the first baseline to determine a first measure of sensor drift for the characteristic of the sensor; comparing the first measure of sensor drift to a first drift threshold; and initiating a self-cleaning session when the first measure of sensor drift exceeds the first drift threshold, the self-cleaning session comprising at least a first self-cleaning cycle.

An aspect according to the method of the preceding paragraph, the method, comprising: detecting, after execution of the first self-cleaning cycle, a third signal from the sensor, the third signal to represent a third baseline for the characteristic of the sensor; comparing the third baseline to the first baseline to determine a second measure of sensor drift for the characteristic of the sensor; and terminating the self-cleaning session when the second measure of sensor drift is less than a second drift threshold.

An aspect according to the method of one of the preceding two paragraphs, wherein: the first drift threshold represents a first level of sensor drift that indicates the self-cleaning session is to be initiated; the second drift threshold represents a second level of sensor drift that indicates the first self-cleaning session was successful; and the second drift threshold is different from the first drift threshold by a specified quantity.

An aspect according to the method of one of the preceding three paragraphs, wherein the specified quantity is a percentage that indicates an amount of reduction in sensor drift to allow the life safety device to reliably detect hazardous conditions.

An aspect according to the method of one of the preceding four paragraphs, comprising: detecting, after execution of the first self-cleaning cycle, a third signal from the sensor, the third signal to represent a third baseline for the characteristic of the sensor; comparing the third baseline to the first baseline to determine a second measure of sensor drift for the characteristic of the sensor; and initiating a second self-cleaning cycle when the second measure of sensor drift is more than a second drift threshold.

An aspect according to the method of one of the preceding five paragraphs, comprising: counting a number of self-cleaning cycles initiated during the self-cleaning session; and comparing the number of self-cleaning cycles to a threshold number of self-cleaning cycles.

An aspect according to the method of one of the preceding six paragraphs, comprising: terminating the self-cleaning session when the number of self-cleaning cycles exceeds the threshold number of self-cleaning cycles.

An aspect according to the method of one of the preceding seven paragraphs, comprising: providing an indication when the number of self-cleaning cycles exceeds the threshold number of self-cleaning cycles, the indication to indicate the self-cleaning session was ineffective to reduce a measure of sensor drift for the characteristic of the sensor below the second drift threshold.

An aspect according to the method of one of the preceding eight paragraphs, wherein the indication comprises a light, an audible alarm, an electronic signal, or a combination thereof.

An aspect according to the method of one of the preceding nine paragraphs, wherein: the sensor is a photoelectric sensor, an ionization sensor, a gas sensor, or a combination thereof; and the characteristic of the sensor is used by the life safety device to detect a hazardous condition.

According to an aspect, there is provided an apparatus, comprising: a sensor to detect a hazardous condition; a control circuit electrically coupled to the sensor, the control circuit to: detect a first signal from the sensor, the first signal to represent a first baseline for a characteristic of the sensor; detect a second signal from the sensor, the second signal to represent a second baseline for the characteristic of the sensor; compare the second baseline to the first baseline to determine a first measure of sensor drift for the characteristic of the sensor; compare the first measure of sensor drift to a first drift threshold; and initiate a self-cleaning session when the first measure of sensor drift exceeds the first drift threshold, the self-cleaning session comprising at least a first self-cleaning cycle.

An aspect according to the apparatus of the preceding paragraph, the apparatus comprising: an audio device electrically coupled to the control circuit, the control circuit to: cause the audio device to vibrate or issue sound waves at an inaudible frequency during each self-cleaning cycle of the self-cleaning session.

An aspect according to the apparatus of one of the preceding two paragraphs, the control circuit to: detect, after execution of the first self-cleaning cycle, a third signal from the sensor, the third signal to represent a third baseline for the characteristic of the sensor; compare the third baseline to the first baseline to determine a second measure of sensor drift for the characteristic of the sensor; and terminate the self-cleaning session when the second measure of sensor drift is less than a second drift threshold.

An aspect according to the apparatus of one of the preceding three paragraphs, the control circuit to: detect, after execution of the first self-cleaning cycle, a third signal from the sensor, the third signal to represent a third baseline for the characteristic of the sensor; compare the third baseline to the first baseline to determine a second measure of sensor drift for the characteristic of the sensor; and initiate a second self-cleaning cycle when the second measure of sensor drift is more than a second drift threshold.

An aspect according to the apparatus of one of the preceding two paragraphs, the apparatus, the control circuit to: count a number of self-cleaning cycles initiated during the self-cleaning session; compare the number of self-cleaning cycles to a threshold number of self-cleaning cycles; and terminate the self-cleaning session when the number of self-cleaning cycles exceeds the threshold number of self-cleaning cycles.

An aspect according to the apparatus of one of the preceding three paragraphs, the control circuit to: provide an indication when the number of self-cleaning cycles exceeds the threshold number of self-cleaning cycles, the indication to indicate the self-cleaning session was ineffective to reduce a measure of sensor drift for the characteristic of the sensor below the second drift threshold.

According to an aspect, there is provided article of manufacture having a non-transitory machine-readable medium, the medium including instructions that, when loaded and executed by a control circuit for a life safety device, cause the control circuit to: detect a first signal from a sensor of the life safety device, the first signal to represent a first baseline for a characteristic of the sensor; detect a second signal from the sensor, the second signal to represent a second baseline for the characteristic of the sensor; compare the second baseline to the first baseline to determine a first measure of sensor drift for the characteristic of the sensor; compare the first measure of sensor drift to a first drift threshold; and initiate a self-cleaning session when the first measure of sensor drift exceeds the first drift threshold, the self-cleaning session comprising at least a first self-cleaning cycle.

An aspect according to the article of manufacture of the preceding paragraph, wherein the instructions cause the control circuit to: detect, after execution of the first self-cleaning cycle, a third signal from the sensor, the third signal to represent a third baseline for the characteristic of the sensor; compare the third baseline to the first baseline to determine a second measure of sensor drift for the characteristic of the sensor; and terminate the self-cleaning session when the second measure of sensor drift is less than a second drift threshold.

An aspect according to the article of manufacture of one of the preceding two paragraphs, wherein the instructions cause the control circuit to: detect, after execution of the first self-cleaning cycle, a third signal from the sensor, the third signal to represent a third baseline for the characteristic of the sensor; compare the third baseline to the first baseline to determine a second measure of sensor drift for the characteristic of the sensor; and initiate a second self-cleaning cycle when the second measure of sensor drift is more than a second drift threshold.

An aspect according to the article of manufacture of one of the preceding three paragraphs, wherein the instructions cause the control circuit to: count a number of self-cleaning cycles initiated during the self-cleaning session; compare the number of self-cleaning cycles to a threshold number of self-cleaning cycles; terminate the self-cleaning session when the number of self-cleaning cycles exceeds the threshold number of self-cleaning cycles; and provide an indication when the number of self-cleaning cycles exceeds the threshold number of self-cleaning cycles, the indication to indicate the self-cleaning session was ineffective to reduce a measure of sensor drift for the characteristic of the sensor below the second drift threshold.

### BRIEF DESCRIPTION OF THE FIGURES

FIG. 1 is an illustration of an apparatus to control operation of an example self-cleaning safety system, according to examples of the present disclosure.

FIG. 2 is an illustration of operation of an apparatus to control operation of an example self-cleaning safety system including example frequencies of operation of a sound device, according to examples of the present disclosure.

FIG. 3 is a more detailed illustration of an apparatus to control operation of an example self-cleaning safety system, according to examples of the present disclosure.

FIG. 4 is a more detailed illustration of operation of an apparatus to control operation of an example self-cleaning safety system, according to examples of the present disclosure.

FIG. 5 is a more detailed illustration of operation of an apparatus to control operation of an example self-cleaning safety system through control of a notch filter, according to examples of the present disclosure.

FIG. 6 is an illustration of an example self-cleaning safety system, according to examples of the present disclosure.

FIG. 7 is an illustration of an example method of operating a self-cleaning safety system, according to examples of the present disclosure.

FIG. 8 is an illustration of another example method of operating a self-cleaning safety system, according to examples of the present disclosure.

FIG. 9 is an illustration of an example method of determining when to initiate a self-cleaning operation for a self-cleaning safety system of a life safety device based on a determination of sensor drift, according to examples of the present disclosure

FIG. 10 is an illustration of an example method of determining whether a self-cleaning operation was effective.

FIG. 11 shows a block diagram of a device having a sensor and a control circuit.

### DETAILED DESCRIPTION

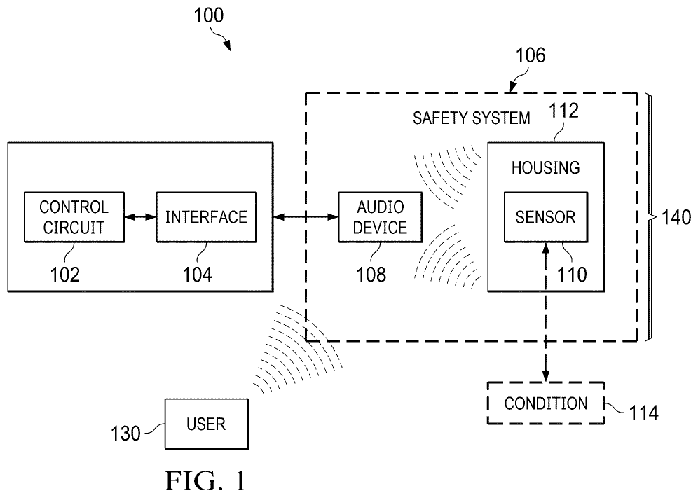

FIG. 1 is an illustration of an apparatus 100 to control operation of an example self-cleaning safety system 106, according to examples of the present disclosure. Apparatus 100 may be included in, or may be separate from, self-cleaning safety system 106. If separate from self-cleaning safety system 106, apparatus 100 may be communicatively connected to self-cleaning safety system 106 in any suitable manner, such as by wires, communication lines, pins, busses, or a wireless communication protocol. If apparatus 100 is included in self-cleaning safety system 106, self-cleaning safety system 106 may be referred to instead as self-cleaning safety system 140, though in the present disclosure self-cleaning safety system 106 will be referred to with the implication that self-cleaning safety system 106 may include apparatus 100.

Apparatus 100 may include a control circuit 102. Control circuit 102 may be configured to control cleaning of safety system housing 112, as well as the cleaning of any components therein or attached thereto in self-cleaning safety system 106.

Self-cleaning safety system 106 may include any suitable safety system, such as a smoke detector, carbon monoxide (CO) detector, radon detector, heat detector, or any suitable combination thereof.

Self-cleaning safety system 106 may include a sensor 110. Sensor 110 may be implemented in any suitable manner and may be configured to detect any suitable physical phenomena or condition 114. Sensor 110 may detect, for example, smoke, heat, CO, or radon, and may provide any suitable signal to a monitor circuit (not shown) to indicate a level of physical phenomena or condition 114 detected by sensor 110. In some examples, sensor 110 may be a photosensor, which may also be referred to as a photodetector or a light sensor. In various examples, the monitor circuit may be implemented within control circuit 102, or separately. The monitor circuit may be configured to, based upon the signal provided from sensor 110, take any suitable corrective action such as alerting one or more users 130 through an audio device, discussed below.

Self-cleaning safety system 100 may include an audio device 108. Audio device 108 may be configured to provide an audible sound to users 130 based upon control signals from the monitor circuit based upon a level of physical phenomena or condition 114 detected by sensor 110. Audio device 108 may be implemented in any suitable manner, such as by a speaker, horn, alarm, or piezoelectric horn or device. Audio device 108 may be configured to oscillate at an audible frequency to alert one or more users 130. Furthermore, audio device 108 may be configured to generate sound waves at an audible frequency to alert one or more users 130. Audio device 108 may produce a high decibel sound as an alarm, e.g., a sound at 65 to 120 decibels (dB) when measured at a distance of 10 feet from the audio device 108, that can be heard even when far away from self-cleaning safety system 106, or by users who are asleep. This high decibel sound may sometimes be used to indicate an alarm fault condition or a need for testing. In various examples, audio device 108 may also be used to clean parts of self-cleaning safety system 106.

Self-cleaning safety system 106 may include a safety system housing 112. Safety system housing 112 may be implemented in any suitable manner to house or hold sensor 110. Moreover, safety system housing 110 may be configured to hold any other suitable portion of self-cleaning safety system 106 or apparatus 100 shown in the figures of the present disclosure. Safety system housing 112 may include grating, gills, or other openings so that sensor 110 may perceive physical phenomena or condition 114. Safety system housing 112 may accumulate dust, debris, particles, or any other substance that may interfere with the detection of physical phenomena or condition 114 by sensor 110. A surface of safety system housing 112 may be made with non-stick coating to as to facilitate cleaning.

Apparatus 100 may include an interface 104 by which control circuit 102 can access elements of self-cleaning safety system 106 such as audio device 108. Interface 104 may include any suitable mechanism by which control circuit 102 may access elements of self-cleaning safety system 106, such as pins, wires, busses, vias, electrical pathways, or any other suitable mechanism for transferring signals.

Control circuit 102 may be configured to cause audio device 108 to clean safety system housing 112. Control circuit 102 may be configured to cause audio device 108 to clean safety system housing 112 to cause dust or other particulate to be dissipated from physical surfaces of safety system housing 112. Control circuit 102 may actuate audio device 108 to vibrate at an inaudible frequency, or issue sound waves at an inaudible frequency, so as to clean safety system housing 112.

Control circuit 102 may be configured to determine to cause cleaning of safety system housing 112 on any suitable basis. Such cleaning may be performed, for example, periodically, on-demand by a user, or based upon a detection of debris. Control circuit 102 may, based on a determination to clean safety system housing 112, cause audio device 108 to vibrate, or issue sound waves, at an inaudible frequency. Operation of audio device 108 is operated to vibrate, or issue sound waves, at an inaudible frequency, may be considered operation of audio device 108 in a cleaning mode. The vibrations of, or sound waves issued by, audio device 108 may be at a frequency lower than the range of audible frequencies, at a frequency higher than the range of audible frequencies, or at a frequency higher and at a frequency lower than the range of audible frequencies, subsequent to one another, without requirement of order. The vibrations of, or sound waves issued, by audio device 108 at both a frequency lower than the range of audible frequencies and at a frequency higher than the range of audible frequencies may provide more effective cleaning than either frequency alone.

The cleaning of safety system housing 112 may be based on fixed intervals, or based on a duration operation, that may be adjusted based on whether self-cleaning safety system 106 is, for example, hardwired or battery operated. The cleaning of safety system housing 112 may be performed more frequently if self-cleaning safety system 106 is hardwired with an external power source.

Moreover, in some examples, the driving of audio device 108 in order to perform cleaning of safety system housing 112 may be performed in conjunction with periodic audio device fault detection by measuring the voltage in feedback from audio device 108. Control circuit 102, or another suitable part of apparatus 100, may evaluate the voltage feedback and ensure that the voltage feedback is within a normal range. Abnormal feedback ranges could indicate a fault and, as a result, an early warning may be sent to a user.

Control circuit 102, and any other monitor circuits, may be implemented in any suitable manner, such as by an application specific integrated circuit (ASIC), field programmable gate array (FPGA), programmable logic device (PLD), reprogrammable logic or hardware, analog circuitry, digital circuitry, digital logic, microcontroller, or instructions for execution by a processor, or any suitable combination thereof.

In various examples, multiple instances of audio device 108 may be used to generate vibrations or sound waves. In other examples, multiple instances of audio devices 108, such as horns, may be used wherein each audio device 108 may generate a different vibration or sound wave frequency. In some examples, audio device 108 or other elements for cleaning safety system housing 112 may be placed within a base of self-cleaning safety system 106, such as a piece that mounts safety system housing 112 to a surface such as a wall or ceiling. In some examples, a non-stick coating, such as Teflon, may be applied to safety system housing 112 so as to allow the vibrations to more easily remove the dust and debris.

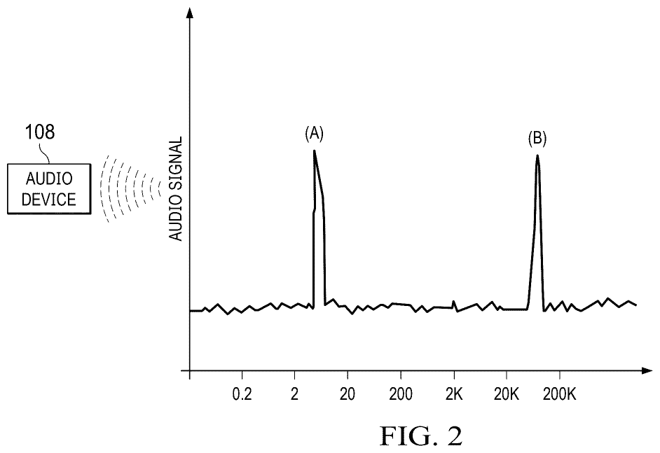

FIG. 2 is an illustration of operation of an apparatus to control operation of an example self-cleaning safety system including example frequencies of operation of a sound device, according to examples of the present disclosure. Specifically, FIG. 2 may illustrate operation of apparatus 100. Audio device 108 may be controlled by apparatus 100 to vibrate or issue sound waves at an inaudible frequency. FIG. 2 illustrates example frequencies of such vibrations or sound waves. For example, audio device 108 may vibrate or issue sound waves at an inaudible frequency within a range of frequencies less than an audible frequency range, such as less than 20 Hz, such as at 18 Hz, shown at (A). In another example, audio device 108 may vibrate or issue sound waves at an inaudible frequency within a range of frequencies greater than an audible frequency range, such as more than 20 KHz, such as at 22 KHz.

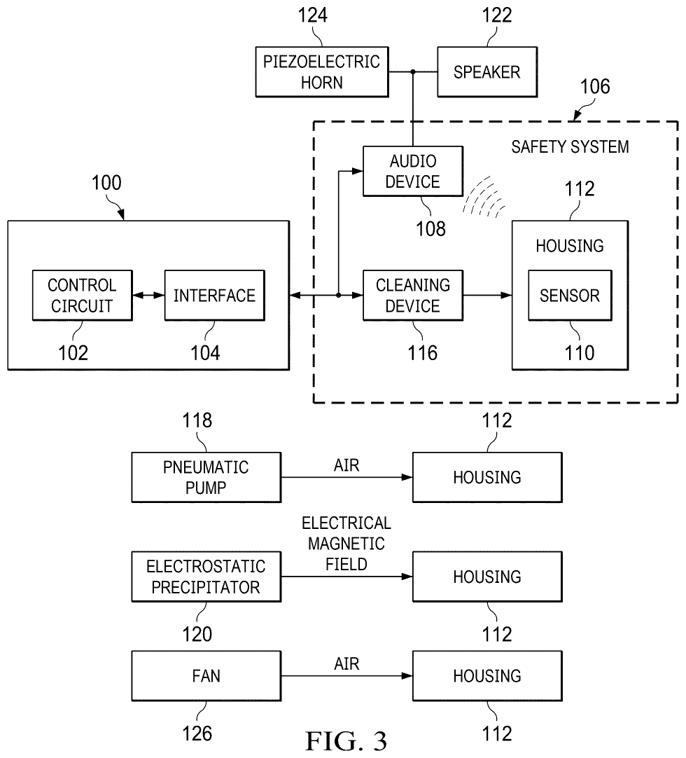

FIG. 3 is a more detailed illustration of an apparatus to control operation of an example self-cleaning life safety system, according to examples of the present disclosure. Specifically, FIG. 3 may illustrate a more detailed view of apparatus 100 and self-cleaning safety system 106.

Apparatus 100 may control any suitable number and kind of additional cleaning devices 116. Cleaning devices 116 may be operated in conjunction with operation of audio device 108 in a cleaning mode. Cleaning device 116 may be implemented in any suitable manner. Cleaning device 116 could be turned on by control circuit 102 during a cleaning mode of self-cleaning safety device 106, and then turned off during a normal mode of self-cleaning safety device 106, so as to not interfere with detection of hazardous conditions by self-cleaning safety device 106.

In one example, an electrostatic precipitator 120 may implement cleaning device 116. Electrostatic precipitator 120 may be configured to collect dust on a plate that was attached to but outside safety system housing 112 or another suitable part of self-cleaning system 106, allowing for easier cleaning. Electrostatic precipitator 120 may generate an electrical magnetic field around portions of safety system housing 112 to collect dust or other debris.

In one example, a pneumatic pump 118 may implement cleaning device 116. Pneumatic pump 118 may be configured to fill an air chamber (not shown) that could then be quickly exhausted or emptied with a quick release valve (not shown) to blow pressurized air out which would remove dust and debris from safety system housing 112.

In one example, a motor-powered fan 126 may implement cleaning device 116. Motor-powered fan 126 may be placed anywhere in self-cleaning safety system 106 to blow dust and debris off safety system housing 112.

In one example, a piezoelectric horn 124 may implement audio device 108. In another example, a speaker 122 may implement audio device 108.

Cleaning device 116 may be turned on by control circuit 102 in any suitable cleaning mode, with the same or different periodicity than the operation of audio device 108 in a cleaning mode. Cleaning device 116 may be activated, for example, every tenth cleaning cycle, i.e. every tenth time that audio device 108 is run in cleaning mode.

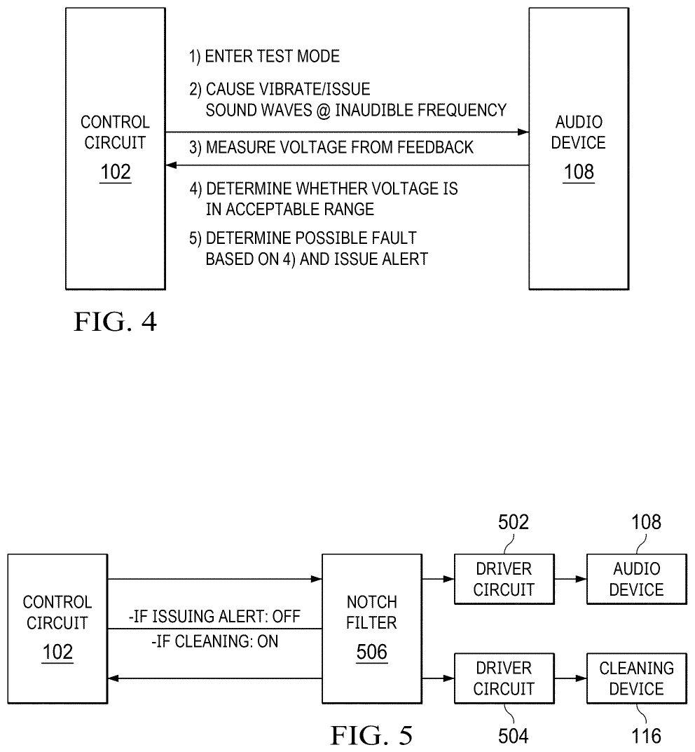

FIG. 4 is a more detailed illustration of operation of an apparatus to control operation of an example self-cleaning life safety system, according to examples of the present disclosure. In particular, FIG. 4 illustrates operation of control circuit 102 upon audio device 108. Moreover, the operation upon audio device 108 may also be performed upon additional cleaning device 116 (not shown).
At (1), control circuit 102 may determine to enter into a test mode of audio device 108. The test mode may include any suitable cleaning mode as discussed above. That is, the test mode and cleaning mode may be performed together.
At (2), control circuit 102 may cause audio device 108 to vibrate or issue sound waves at an inaudible frequency.
At (3), control circuit 102 may receive or measure voltage from feedback from audio device 108.
At (4), control circuit 102 may determine whether the voltage from feedback from audio device 108 is within an acceptable range.
At (5), control circuit 102 may determine a possible fault of audio device 108 based upon the determination in (4) and issue an alert.

FIG. 5 is a more detailed illustration of operation of an apparatus to control operation of an example self-cleaning safety system to vibrate or issue sound waves at an inaudible frequency through control of a notch filter, according to examples of the present disclosure.

Control circuit 102 may utilize one or more driver circuits to drive audio device 108 or cleaning device 116. Such driver circuits may be implemented in any suitable manner, such as by an ASIC, FPGA, PLD, reprogrammable logic or hardware, analog circuitry, digital circuitry, digital logic, microcontroller, instructions for execution by a processor, or any suitable combination thereof. Such driver circuits may be configured to perform any suitable signal conditioning upon control signals issued by control circuit 102 so that such control signals may effect control upon audio device 108 or cleaning device 116. Such driver circuits may be implemented in any suitable location, such as within apparatus 100 or self-cleaning safety system 106. A single driver circuit may be used for both audio device 108 and cleaning device 116, or, as shown in the example of FIG. 5, separate driver circuits 502, 504 may be used for audio device 108 and cleaning device 116, respectively.

A notch filter 506 may be placed on any control lines between control circuit 102 and audio device 108 and cleaning device 116. For example, notch filter 506 may be placed between control circuit 102 and driver circuits 502, 504. Notch filter 506 may be implemented in any suitable manner, such as by an ASIC, FPGA, PLD, reprogrammable logic or hardware, analog circuitry, digital circuitry, digital logic, instructions for execution by a processor, or any suitable combination thereof.

Notch filter 506 may be activated by control circuit 102 when self-cleaning safety system 106 is in a cleaning mode, and may be deactivated by control circuit 102 when self-cleaning safety system 106 is in a normal mode. Notch filter 506 may allow audio device 108 or cleaning device 116 to only operate at the frequencies of interest, i.e. inaudible frequency or frequencies. For example, piezoelectric horns may resonate at other audible peaks that waste energy and produce audible sounds.

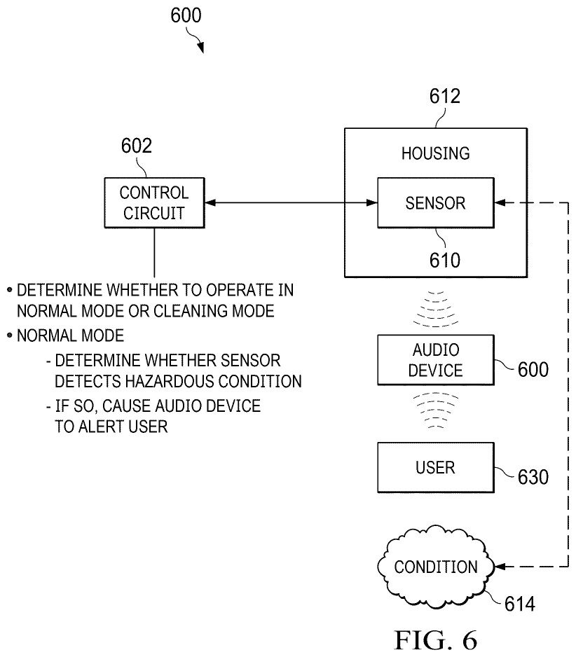

FIG. 6 is an illustration of an example self-cleaning safety apparatus 600, according to examples of the present disclosure. Apparatus 600 may implement portions of FIGS. 1-5. Apparatus 600 may include a sensor 610 to detect a hazardous condition 614. Apparatus 600 may include an audio device 608 to alert a user 630 of hazardous condition 614. Apparatus 600 may include a safety system housing 612 to house sensor 610. Apparatus 600 may include a control circuit 602 to determine whether to operate apparatus 600 in a cleaning mode or in a normal mode. Control circuit 602 may be configured to, based on a determination to operate apparatus 600 in the normal mode, determine whether sensor 610 has detected hazardous condition 614. Control circuit 602 may be configured to, based on a determination that sensor 610 has detected hazardous condition 614, cause audio device 608 to alert user 630 of hazardous condition 614, by driving audio device 608 to vibrate or issue sound waves at an audible frequency. Control circuit 602 may be configured to, based on a determination to operate apparatus 600 in the cleaning mode, cause a cleaning of safety system housing 612 by causing audio device 608 to vibrate or issue sound waves at an inaudible frequency.

Control circuit 602 may be implemented as described above with respect to control circuit 102. Safety system housing 612 may be implemented as described above with respect to safety system housing 112. Sensor 610 may be implemented as described above with respect to sensor 110. Audio device 608 may be implemented as described above with respect to audio device 108. Condition 614 may be as described above with respect to condition 114. User 630 may be any suitable user of apparatus 600. Apparatus 600 may be implemented as described above with respect to system 106.

Moreover, as shown in FIG. 2 with respect to control circuit 102, control circuit 602 may be configured to, based on the determination to operate apparatus 600 in the cleaning mode, cause audio device 608 to vibrate or issue sound waves at the inaudible frequency by causing audio device 608 to vibrate or issue sound waves at a frequency higher than a range of audible frequencies, or at a frequency lower than a range of audible frequencies, or both.

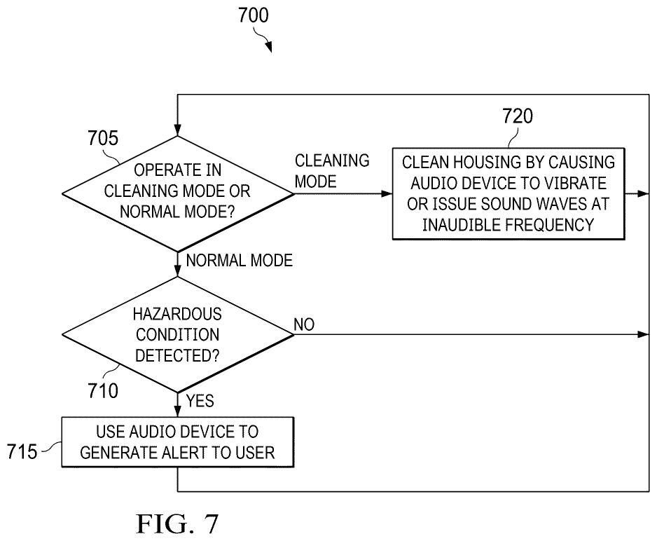

FIG. 7 is an illustration of an example method 700 of operating a self-cleaning safety system, according to examples of the present disclosure. Method 700 may be performed by any suitable elements, such as those of control circuits as shown in FIGS. 1-6. Method 700 may be executed with more or fewer steps than shown in FIG. 7, and the steps of method 900 may be optionally omitted, repeated, performed in a different order, performed in parallel, or recursively.

At 705, it may be determined whether to operate an apparatus in a cleaning mode or in a normal mode. If the apparatus is to be operated in the normal mode, method 700 may proceed to 710. Otherwise, method 700 may proceed to 720.

At 710, based on a determination to operate the apparatus in the normal mode, it may be determined whether a sensor of the apparatus has detected a hazardous condition. If a hazardous condition has been detected, method 700 may proceed to 715. Otherwise, method 700 may return to 705.

At 715, based on a determination that the sensor has detected the hazardous condition, an audio device of the apparatus may be caused to alert a user of the hazardous condition. The alert may be audible. The alert may be generated by an audio device such as a piezoelectric horn or a speaker vibrating or issuing sound waves in one or more audible frequencies. Method 700 may return to 705.

At 720, based on a determination to operate the apparatus in the cleaning mode, a cleaning of a housing of the sensor may be caused by causing the audio device to vibrate or issue sound waves at an inaudible frequency. Method 700 may return to 705.

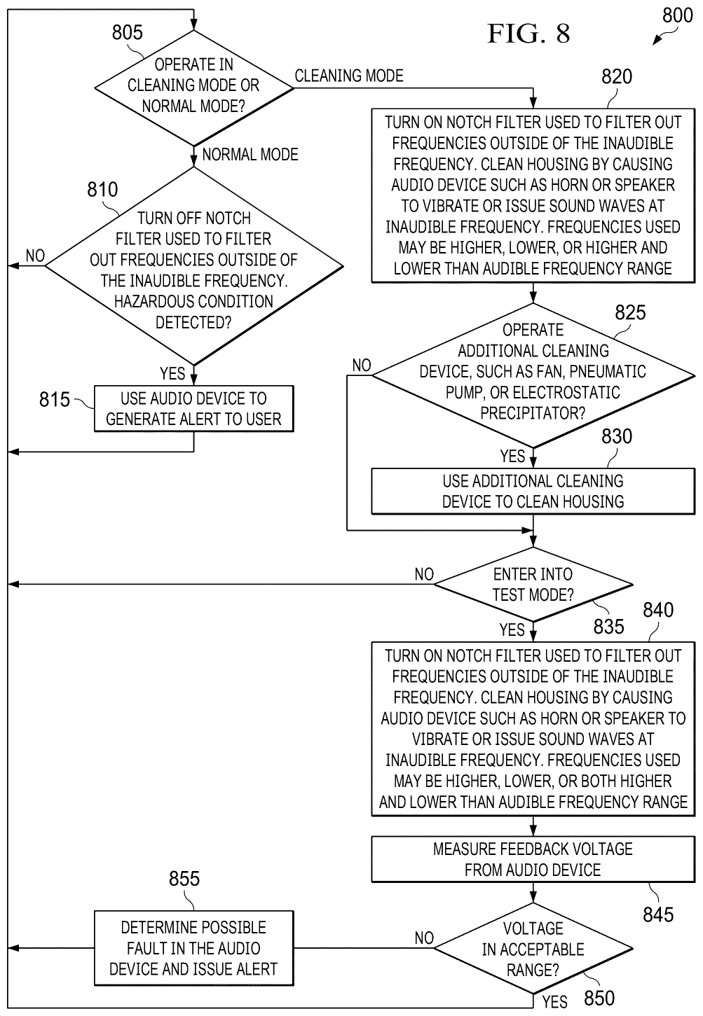

FIG. 8 is an illustration of an example method 800 of operating a self-cleaning safety system, according to examples of the present disclosure. Method 800 may be performed by any suitable elements, such as those of control circuits as shown in FIGS. 1-6. Method 800 may be executed with more or fewer steps than shown in FIG. 8, and the steps of method 800 may be optionally omitted, repeated, performed in a different order, performed in parallel, or recursively.

At 805, it may be determined whether to operate an apparatus in a cleaning mode or in a normal mode. If the apparatus is to be operated in the normal mode, method 800 may proceed to 810. Otherwise, method 800 may proceed to 820.

At 810, based on a determination to operate the apparatus in the normal mode, a notch filter used to filter out frequencies outside of the inaudible frequency may be turned off. It may be determined whether a sensor of the apparatus has detected a hazardous condition. If a hazardous condition has been detected, method 800 may proceed to 815. Otherwise, method 800 may return to 805.

At 815, based on a determination that the sensor has detected the hazardous condition, an audio device of the apparatus may be caused to alert a user of the hazardous condition. The alert may be audible. The alert may be generated by an audio device such as a piezoelectric horn or a speaker vibrating or issuing sound waves in one or more audible frequencies. Method 800 may return to 805.

At 820, based on a determination to operate the apparatus in the cleaning mode, a notch filter to filter out frequencies outside of the inaudible frequency may be turned on. A cleaning of a housing of the sensor may be caused by causing the audio device to vibrate or issue sound waves at an inaudible frequency. The audio device may be caused to vibrate or issue sound waves at a frequency higher than a range of audible frequencies, lower than the range of audible frequencies, or higher and lower than the range of audible frequencies. The audio device may be the same audio device that was used to alert a user in 815. The audio device may be a piezoelectric horn or a speaker, for example.

At 825, it may be determined whether an additional cleaning device will be used to clean the housing. If so, method 800 may proceed to 830. Otherwise, method 800 may proceed to 835.

At 830, based on the determination to operate the apparatus in the cleaning mode and to use an additional cleaning device, the additional cleaning device may be caused to clean the sensor. The additional cleaning device may include, for example, an electrostatic precipitator, pneumatic pump, or fan. Method 800 may proceed to 835.

At 835, it may be determined whether a test mode is to be entered into in conjunction with the cleaning mode. If so, method 800 may proceed to 840. Otherwise, method 800 may return to 805.

At 840, the audio device may be caused to vibrate or issue sound waves at the inaudible frequency. This may be a same or a different option as performed in 820, i.e. a notch filter to filter out frequencies outside of the inaudible frequency may be turned on.

At 845, feedback from the audio device may be measured. The feedback may result from causing the audio device to vibrate or issue sound waves at the inaudible frequency.

At 850, it may be determined whether the voltage is in an acceptable range. If so, method 800 may return to 805. Otherwise, method 800 may proceed to 855.

At 855, based upon a determination that the voltage is not within the acceptable range, a possible fault in the audio device may be determined and an alert issued. Method 800 may return to 805.

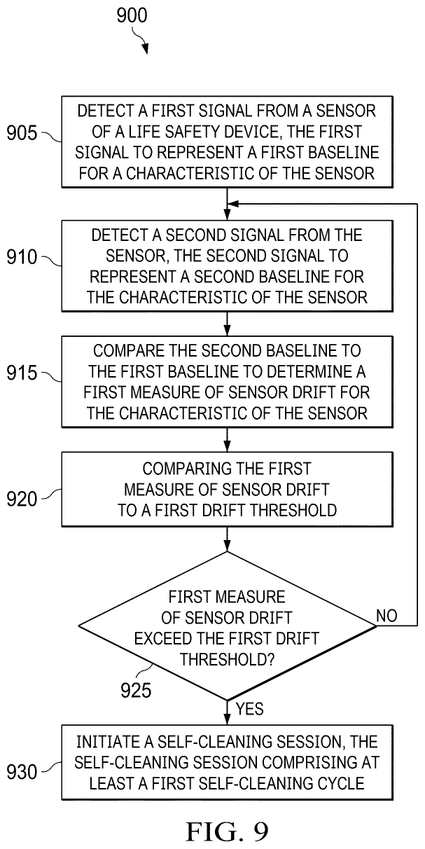

FIG. 9 is an illustration of an example method 900 of determining when to initiate a self-cleaning operation for a self-cleaning safety system of a life safety device based on a determination of sensor drift, according to examples of the present disclosure. The self-cleaning safety system and operation of the self-cleaning safety system may be as described in FIGS. 1-8. Method 900 may be performed by any suitable elements, such as those of control circuits as shown in FIGS. 1-6. Method 900 may be executed with more or fewer steps than shown in FIG. 9, and the steps of method 900 may be optionally omitted, repeated, performed in a different order, performed in parallel, or recursively.

At 905, a first signal from a sensor of a life safety device may be detected. The first signal may represent an initial or first baseline for a characteristic of the sensor. The initial baseline for the characteristic of the sensor may be stored in a memory of the life safety device. In some examples, the initial baseline may be stored in memory external to the life safety device, e.g., in a database. The initial baseline may be determined when the life safety device is manufactured. Alternatively, the initial baseline may be determined after the life safety device is installed in a location to monitor for environmental conditions, including hazardous conditions. In some examples, the characteristic of the sensor may be a level of light detected in a photoelectric detector or change in ionization current in an ionization detector. In some examples, the characteristic of the sensor may be a level of gas detected by a gas sensor, wherein the gas detected may be carbon monoxide (CO) or carbon dioxide (CO₂). In some examples, the characteristic of the sensor may be represented by a voltage value or a current value.

At 910, a second signal from the sensor may be detected. The second signal may represent an adjusted or second baseline for the characteristic of the sensor. The second signal may be detected while the life safety device is operating in a normal mode of operation, as described herein. The first adjusted baseline may represent a change in the baseline from the initial baseline over time, e.g., as dust or other debris have accumulated on components of the life safety device.

At 915, the second baseline may be compared to the first baseline to determine a first measure of sensor drift for the characteristic of the sensor. The amount of sensor drift may indicate that dust or other debris has accumulated on components of the life safety device, e.g., the sensor or a housing for the sensor.

At 920, the first measure of sensor drift may be compared to a first drift threshold value. In some examples, the first drift threshold value may indicate a maximum allowable amount of sensor drift for the life safety device before a self-cleaning cycle is initiated.

At 925, it may be determined whether the first measure of sensor drift exceeds the first drift threshold. If yes, method 900 may proceed to 930. If no, method 900 may return to 910. In some examples, a first self-cleaning cycle may be initiated based on the first measure of sensor drift exceeding the threshold value.

At 930, a self-cleaning session may be initiated based on the determination at 925. This may result in a determination that the life safety device is to operate in cleaning mode as described herein, for example, a determination at 705 of method 700 or a determination at 805 of method 800.

In some examples, multiple self-cleaning cycles may be initiated based on subsequent measures of sensor drift exceeding the first drift threshold. The self-cleaning session may be terminated after the measure of sensor drift is improved by a predetermined amount or after a count of the number of self-cleaning cycles meets or exceeds a threshold value indicating the maximum number of self-cleaning cycles to initiate in a self-cleaning session.

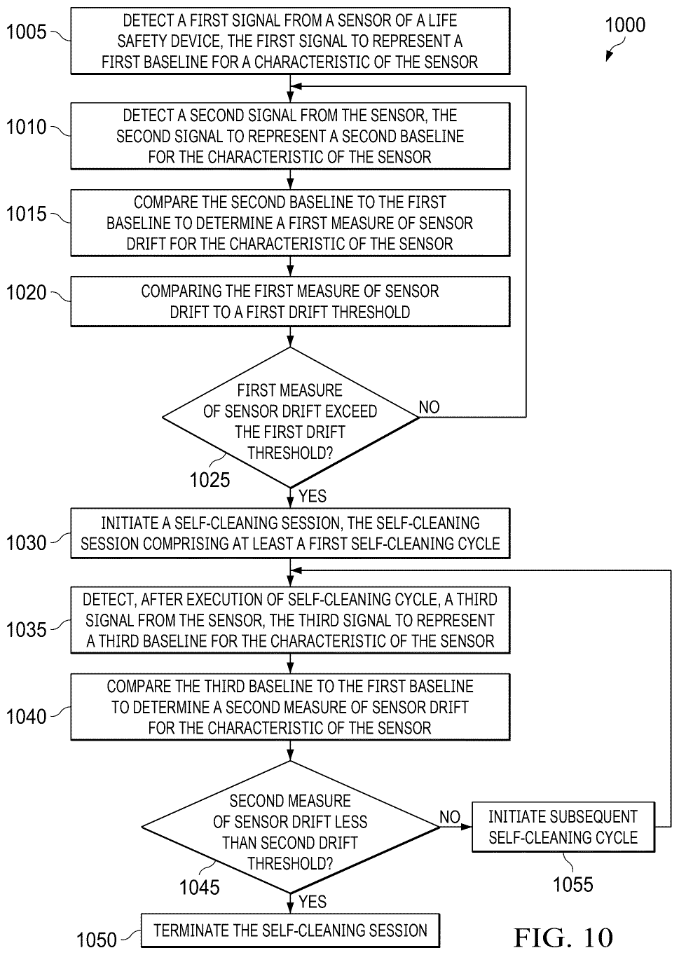

FIG. 10 is an illustration of an example method 1000 of determining whether a self-cleaning operation is to be terminated. The self-cleaning safety system and operation of the self-cleaning safety system may be as described in FIGS. 1-9. Method 1000 may be performed by any suitable elements, such as those of control circuits as shown in FIGS. 1-6. Method 1000 may be executed with more or fewer steps than shown in FIG. 10, and the steps of method 1000 may be optionally omitted, repeated, performed in a different order, performed in parallel, or recursively.

At 1005, a first signal from a sensor of a life safety device may be detected. The first signal may represent an initial or first baseline for a characteristic of the sensor. The initial baseline for the characteristic of the sensor may be stored in a memory of the life safety device. In some examples, the initial baseline may be stored in memory external to the life safety device, e.g., in a database. The initial baseline may be determined when the life safety device is manufactured. Alternatively, the initial baseline may be determined after the life safety device is installed in a location to monitor for environmental conditions, including hazardous conditions. In some examples, the characteristic of the sensor may be a level of light detected for a photoelectric detector or change in ionization current for an ionization detector. In some examples, the characteristic of the sensor may be represented by a voltage value or a current value.

At 1010, a second signal from the sensor may be detected. The second signal may represent an adjusted or second baseline for the characteristic of the sensor. The second signal may be detected while the life safety device is operating in a normal mode of operation, as described herein. The first adjusted baseline may represent a change in the baseline from the initial baseline over time, e.g., as dust or other debris have accumulated on components of the life safety device.

At 1015, the second baseline may be compared to the first baseline to determine a first measure of sensor drift for the characteristic of the sensor. The amount of sensor drift may indicate that dust or other debris has accumulated on components of the life safety device, e.g., the sensor or a housing for the sensor.

At 1020, the first measure of sensor drift may be compared to a first drift threshold value. In some examples, the first drift threshold value may indicate a maximum allowable amount of sensor drift for the life safety device before a self-cleaning cycle is initiated.

At 1025, it may be determined whether the first measure of sensor drift exceeds the first drift threshold. If yes, method 1000 may proceed to 1030. If no, method 1000 may return to 1010. In some examples, a first self-cleaning cycle may be initiated based on the first measure of sensor drift exceeding the threshold value.

At 1030, a first self-cleaning session may be initiated based on the determination at 1025. This may result in a determination that the life safety device is to operate in cleaning mode as described herein, for example, a determination at 705 of method 700 or a determination at 805 of method 800.

At 1035, after execution of the self-cleaning cycle, a third signal from the sensor may be detected, the third signal to represent a third baseline for the characteristic of the sensor. The third baseline may indicate the change in the baseline for the characteristic of the sensor after a self- cleaning cycle is completed.

At 1040, the third baseline may be compared to the first baseline to determine a second measure of sensor drift for the characteristic of the sensor.

At 1045, it may be determined whether the second measure of sensor drift is less than a second drift threshold. If yes, method 1000 may proceed to 1050. If no, method 1000 may proceed to 1055.

At 1050, the self-cleaning session may be terminated based on the determination at 1045. The life safety device may then return to normal operation mode, as described herein.

At 1055, a subsequent self-cleaning cycle may be initiated based on the determination at 1045. Method 1000 may then return to 1035, and a number of subsequent self-cleaning sessions may be initiated until the second measure of sensor drift is below the second drift threshold. The subsequent self-cleaning cycle at 1055 may be implemented in the same manner as the first self-cleaning cycle at 1030.

In various examples described herein, the first drift threshold may represent a first level of sensor drift that indicates a self-cleaning session is to be initiated. The second drift threshold may represent a second level of sensor drift that indicates the first self-cleaning session, which may include one or more self-cleaning cycles, was successful. The second drift threshold may be different from the first drift threshold by a specified quantity. In some examples, the specified quantity may be a percentage (e.g., 10%, 20%, or 50%, without limitation) that indicates an amount of reduction in sensor drift to allow the life safety device to reliably detect hazardous conditions. In some examples, the specified quantity may be a predetermined value for the characteristic of the sensor. For example, the second drift threshold may represent a baseline level for a characteristic of the sensor where the sensor has sufficient headroom to reliably detect environmental conditions, including hazardous conditions. A self-cleaning session may be considered successful, e.g., when the desired amount of headroom is achieved.

In the various examples described herein, a self-cleaning session may be alternatively terminated based on a number of self-cleaning cycles being initiated. For example, a method of terminating a self-cleaning session may include the following: counting the number of self-cleaning cycles initiated during a self-cleaning session; comparing the number of self-cleaning cycles to a threshold number of self-cleaning cycles; and terminating the self-cleaning session when the number of self-cleaning cycles exceeds the threshold number of self-cleaning cycles. The threshold number of self-cleaning cycles may be predetermined and may represent the maximum number of self-cleaning cycles to initiate before additional corrective actions are to be taken. This may help prevent a life safety device from becoming stuck in a self-cleaning mode. If the self-cleaning session is terminated based on exceeding the threshold number of self-cleaning cycles before a self-cleaning cycles is determined to be successful, an indication may be provided. The indication may be provided when the number of self-cleaning cycles exceeds the threshold number of self-cleaning cycles. The indication may indicate the self-cleaning session was ineffective to reduce a measure of sensor drift for the characteristic of the sensor below the second drift threshold. The indication may be any suitable indications, and may include, without limitation, a light, an audible alarm, an electronic signal, or a combination thereof. The life safety device may return to a normal operation mode with the indication indicating the life safety device is operating with a level of sensor drift that exceeds the threshold value. The indications may be used to facilitate further corrective actions. For example, a maintenance person may be dispatched to inspect, clean, repair, or replace the sensor or the life safety device.

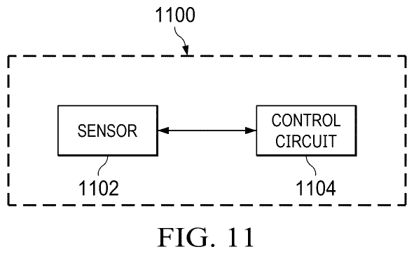

FIG. 11 shows a block diagram of a device 1100 having a sensor 1102 and a control circuit 1104. The control circuit 1104 may be to: detect a first signal from sensor 1102, the first signal to represent a first baseline for a characteristic of sensor 1102; detect a second signal from sensor 1102, the second signal to represent a second baseline for the characteristic of sensor 1102; compare the second baseline to the first baseline to determine a first measure of sensor drift for the characteristic of sensor 1102; compare the first measure of sensor drift to a first drift threshold; and initiate a self-cleaning session when the first measure of sensor drift exceeds the first drift threshold, the self-cleaning session comprising at least a first self-cleaning cycle.

Device 1100 may be a life safety device. Control circuit 1104 may be to perform various methods disclosed herein. In some examples, device 1100 may include additional circuitry and devices as described herein. In some examples, device 1100 may include a memory (not shown) to store data and instructions used by control circuit 1104.

Examples of the present disclosure may include a non-transitory machine-readable medium, the medium including instructions that, when loaded and executed by a control circuit for a life safety device, cause the control circuit to perform various methods disclosed herein.

Examples of the present disclosure may include an apparatus.

The apparatus may include a control circuit. The control circuit may be implemented in any suitable manner, such as by an application specific integrated circuit, field programmable gate array, programmable logic device, reprogrammable logic or hardware, analog circuitry, digital circuitry, digital logic, microcontroller, or instructions for execution by a processor, or any suitable combination thereof.

The control circuit may be configured to connect to an audio device of a safety system. The safety system may include any suitable safety system, such as a smoke detector, carbon monoxide (CO) detector, radon detector, heat detector, or any suitable combination thereof.

The audio device may be implemented in any suitable manner, such as by a speaker, horn, alarm, or piezoelectric horn or device. The audio device may be configured to oscillate at an audible frequency to alert one or more users. Furthermore, the audio device may be configured to generate sound waves at an audible frequency to alert one or more users.

The safety system may include a sensor to sense the hazardous condition. The sensor may be implemented in any suitable manner and may be configured to detect any suitable physical phenomena or condition such as smoke, heat, CO, radon, or other toxic gases or environmental conditions, and may provide any suitable signal to a control circuit or a monitor circuit to indicate a level of physical phenomena or condition detected by the sensor. The thing being sensed or measured by the sensor may be referred to as a characteristic of the sensor. For example, a photosensor may sense or measure an amount of light and based on that characteristic of the sensor being detected, a life safety device may detect a hazardous condition such as smoke or fire. The characteristic of the sensor may be represented by an electrical signal, e.g., by a voltage value or a current value.

The apparatus may include an interface to connect the control circuit to the audio device. The interface may include any suitable mechanism by which the control circuit may access elements of the safety system, such as pins, wires, busses, vias, electrical pathways, or any other suitable mechanism for transferring signals.

The control circuit may be configured to determine whether to clean a housing of the sensor, and, based on a determination to clean the housing of sensor, cause the audio device to vibrate or issue sound waves at an inaudible frequency.

In combination with any of the above examples, the control circuit may be configured to, based on the determination to clean the housing of the sensor, cause the audio device to vibrate or issue sound waves at the inaudible frequency by causing the audio device to vibrate or issue sound waves at a frequency higher than a range of audible frequencies.

In combination with any of the above examples, the control circuit may be configured to, based on the determination to clean the housing of the sensor, cause the audio device to vibrate or issue sound waves at the inaudible frequency by causing the audio device to vibrate or issue sound waves at a frequency lower than a range of audible frequencies.

In combination with any of the above examples, the control circuit may be configured to, based on the determination to clean the housing of the sensor, cause the audio device to vibrate or issue sound waves at the inaudible frequency by causing the audio device to vibrate or issue sound waves at a first frequency higher than a range of audible frequencies and at a second frequency lower than the range of audible frequencies.

In combination with any of the above examples, the control circuit may be configured to, based on the determination to clean the housing of the sensor, cause an additional cleaning device to clean the housing of the sensor.

In combination with any of the above examples, the additional cleaning device may be an electrostatic precipitator to clean the housing of the sensor.

In combination with any of the above examples, the additional cleaning device may be a pneumatic pump to clean the housing of the sensor.

In combination with any of the above examples, the additional cleaning device may be a fan to clean the housing of the sensor.

In combination with any of the above examples, the audio device may be a horn or speaker.

In combination with any of the above examples, the control circuit may be configured to, in a test mode, cause the audio device to vibrate or issue sound waves at the inaudible frequency on a periodic basis, measure voltage from feedback from the audio device resulting from causing the audio device to vibrate or issue sound waves at the inaudible frequency, determine whether the voltage is in an acceptable range, and, based upon a determination that the voltage is not within the acceptable range, determine a possible fault in the audio device and issue an alert.

In combination with any of the above examples, the control circuit may be configured to control a notch filter to filter out frequencies outside of the inaudible frequency, including to turn off the notch filter when the audio device is issuing the alert to the user about the hazardous condition and to turn on the notch filter when causing the audio device to clean the housing.

Examples of the present disclosure may include an apparatus. The apparatus may include any of the apparatuses of the above examples, including the control circuits therein. The apparatus may include the sensor, the audio device, and the housing.

Examples of the present disclosure may include methods performed by any of the above examples.

Although example examples have been described above, other variations and examples may be made from this disclosure without departing from the spirit and scope of these examples.

What is claimed is:

1. A method, comprising:
detecting a first signal from a sensor of a life safety device, the first signal to represent a first baseline for a characteristic of the sensor;
detecting a second signal from the sensor, the second signal to represent a second baseline for the characteristic of the sensor;
comparing the second baseline to the first baseline to determine a first measure of sensor drift for the characteristic of the sensor;
comparing the first measure of sensor drift to a first drift threshold; and
initiating a self-cleaning session when the first measure of sensor drift exceeds the first drift threshold, the self-cleaning session comprising at least a first self-cleaning cycle.

2. The method of claim 1, comprising:
detecting, after execution of the first self-cleaning cycle, a third signal from the sensor, the third signal to represent a third baseline for the characteristic of the sensor;
comparing the third baseline to the first baseline to determine a second measure of sensor drift for the characteristic of the sensor; and
terminating the self-cleaning session when the second measure of sensor drift is less than a second drift threshold.

3. The method of claim 2, wherein:
the first drift threshold represents a first level of sensor drift that indicates the self-cleaning session is to be initiated;
the second drift threshold represents a second level of sensor drift that indicates the first self-cleaning session was successful; and
the second drift threshold is different from the first drift threshold by a specified quantity.

4. The method of claim 3, wherein the specified quantity is a percentage that indicates an amount of reduction in sensor drift to allow the life safety device to reliably detect hazardous conditions.

5. The method of claim 1, comprising:
detecting, after execution of the first self-cleaning cycle, a third signal from the sensor, the third signal to represent a third baseline for the characteristic of the sensor;
comparing the third baseline to the first baseline to determine a second measure of sensor drift for the characteristic of the sensor; and
initiating a second self-cleaning cycle when the second measure of sensor drift is more than a second drift threshold.

6. The method of claim 1, comprising:
counting a number of self-cleaning cycles initiated during the self-cleaning session; and
comparing the number of self-cleaning cycles to a threshold number of self-cleaning cycles.

7. The method of claim 6, comprising:
terminating the self-cleaning session when the number of self-cleaning cycles exceeds the threshold number of self-cleaning cycles.

8. The method of claim 7, comprising:
providing an indication when the number of self-cleaning cycles exceeds the threshold number of self-cleaning cycles, the indication to indicate the self-cleaning session was ineffective to reduce a measure of sensor drift for the characteristic of the sensor below a second drift threshold.

9. The method of claim 8, wherein the indication comprises a light, an audible alarm, an electronic signal, or a combination thereof.

10. The method of claim 1, wherein:
the sensor is a photoelectric sensor, an ionization sensor, a gas sensor, or a combination thereof; and
the characteristic of the sensor is used by the life safety device to detect a hazardous condition.

11. An apparatus, comprising:
a sensor to detect a hazardous condition;
a control circuit electrically coupled to the sensor, the control circuit to:
detect a first signal from the sensor, the first signal to represent a first baseline for a characteristic of the sensor;
detect a second signal from the sensor, the second signal to represent a second baseline for the characteristic of the sensor;
compare the second baseline to the first baseline to determine a first measure of sensor drift for the characteristic of the sensor;
compare the first measure of sensor drift to a first drift threshold; and
initiate a self-cleaning session when the first measure of sensor drift exceeds the first drift threshold, the self-cleaning session comprising at least a first self-cleaning cycle.

12. The apparatus of claim 11, comprising:
an audio device electrically coupled to the control circuit, the control circuit to:
cause the audio device to vibrate or issue sound waves at an inaudible frequency during each self-cleaning cycle of the self-cleaning session.

13. The apparatus of claim 11, the control circuit to:
detect, after execution of the first self-cleaning cycle, a third signal from the sensor, the third signal to represent a third baseline for the characteristic of the sensor;
compare the third baseline to the first baseline to determine a second measure of sensor drift for the characteristic of the sensor; and
terminate the self-cleaning session when the second measure of sensor drift is less than a second drift threshold.

14. The apparatus of claim 11, the control circuit to:
detect, after execution of the first self-cleaning cycle, a third signal from the sensor, the third signal to represent a third baseline for the characteristic of the sensor;
compare the third baseline to the first baseline to determine a second measure of sensor drift for the characteristic of the sensor; and
initiate a second self-cleaning cycle when the second measure of sensor drift is more than a second drift threshold.

15. The apparatus of claim 11, the control circuit to:
count a number of self-cleaning cycles initiated during the self-cleaning session;
compare the number of self-cleaning cycles to a threshold number of self-cleaning cycles; and
terminate the self-cleaning session when the number of self-cleaning cycles exceeds the threshold number of self-cleaning cycles.

16. The apparatus of claim 15, the control circuit to:
provide an indication when the number of self-cleaning cycles exceeds the threshold number of self-cleaning cycles, the indication to indicate the self-cleaning session was ineffective to reduce a measure of sensor drift for the characteristic of the sensor below a second drift threshold.

17. An article of manufacture, comprising a non-transitory machine-readable medium, the medium including instructions that, when loaded and executed by a control circuit for a life safety device, cause the control circuit to:
detect a first signal from a sensor of the life safety device, the first signal to represent a first baseline for a characteristic of the sensor;
detect a second signal from the sensor, the second signal to represent a second baseline for the characteristic of the sensor;
compare the second baseline to the first baseline to determine a first measure of sensor drift for the characteristic of the sensor;
compare the first measure of sensor drift to a first drift threshold; and
initiate a self-cleaning session when the first measure of sensor drift exceeds the first drift threshold, the self-cleaning session comprising at least a first self-cleaning cycle.

18. The article of manufacture of claim 17, wherein the instructions cause the control circuit to:
detect, after execution of the first self-cleaning cycle, a third signal from the sensor, the third signal to represent a third baseline for the characteristic of the sensor;
compare the third baseline to the first baseline to determine a second measure of sensor drift for the characteristic of the sensor; and
terminate the self-cleaning session when the second measure of sensor drift is less than a second drift threshold.

19. The article of manufacture of claim 17, wherein the instructions cause the control circuit to:
detect, after execution of the first self-cleaning cycle, a third signal from the sensor, the third signal to represent a third baseline for the characteristic of the sensor;
compare the third baseline to the first baseline to determine a second measure of sensor drift for the characteristic of the sensor; and
initiate a second self-cleaning cycle when the second measure of sensor drift is more than a second drift threshold.

20. The article of manufacture of claim 17, wherein the instructions cause the control circuit to:
count a number of self-cleaning cycles initiated during the self-cleaning session;
compare the number of self-cleaning cycles to a threshold number of self-cleaning cycles;
terminate the self-cleaning session when the number of self-cleaning cycles exceeds the threshold number of self-cleaning cycles; and
provide an indication when the number of self-cleaning cycles exceeds the threshold number of self-cleaning cycles, the indication to indicate the self-cleaning session was ineffective to reduce a measure of sensor drift for the characteristic of the sensor below a second drift threshold.
